(19) United States
(12) Patent Application Publication
(10) Pub. No.: US 2019/0026719 A1
(43) Pub. Date: Jan. 24, 2019

(54) POINT OF SALE APPARATUS SUPPORTING MULTIPLE LANGAUGES

(71) Applicant: TOSHIBA TEC KABUSHIKI KAISHA, Tokyo (JP)

(72) Inventor: Takanori KOSHIMAE, Kawasaki Kanagawa (JP)

(21) Appl. No.: 16/020,220

(22) Filed: Jun. 27, 2018

(30) Foreign Application Priority Data
Jul. 18, 2017 (JP) 2017-139440

(51) Int. Cl. G06Q 20/20

(52) U.S. Cl. CPC G06Q 20/209; G06Q 20/208

(57) ABSTRACT

A point of sale apparatus according to an embodiment includes an input device, an output device, and a processor. The processor is programmed to receive commodity information corresponding to a commodity that is a subject of a transaction, and generate receipt data including a first character string indicating a name of the commodity in a first language. The input device receives a selection of a second language different from the first language. The processor adds, to the generated receipt data, a second character string indicating a name of the commodity in the selected second language, and performs a settlement processing of the transaction based on the received commodity information. The output device outputs the receipt data including the first character string and the second character string.

### CROSS-REFERENCE TO RELATED APPLICATION

This application is based upon and claims the benefit of priority from Japanese Patent Application No. 2017-139440, filed Jul. 18, 2017, the entire contents of which are incorporated herein by reference.

### FIELD

Embodiments described herein relate generally to a point of sale apparatus that supports multiple languages.

### BACKGROUND

In the related art, a sales data processing apparatus such as a point of sale (POS) terminal is used in a retail store such as a supermarket. The sales data processing apparatus performs processing relating to settlement of a commodity purchased by a customer and issues a receipt on which transaction content is printed. The customer can confirm a history, an amount of money, and the like of the purchased commodity by reading the issued receipt.

In addition, recently, a tourist who visits Japan for shopping, sightseeing, and the like has been increasing. Some tourists visiting Japan cannot understand Japanese, but can easily understand other languages (for example, a mother tongue) different from Japanese. In such a case, the tourists visiting Japan cannot understand the receipt printed in Japanese, and thus, a technology for printing a receipt using languages other than Japanese is proposed in the related art. In addition, a technology is proposed in which a receipt printed in Japanese and a receipt printed in another language are individually printed.

However, if a commodity is exchanged or returned, it is common for a store clerk to respond after confirming a transaction history printed on the receipt. However, there is a possibility that, if the receipt is printed in another language as described above, the store clerk cannot understand the content printed on the receipt and cannot easily confirm which commodity is subject to exchange or returning. In addition, if a receipt is printed on a per language basis, a store clerk confirms the commodity corresponding to a character string in a receipt written in Japanese with a receipt written another language. Thus, the related art is inconvenient.

### DESCRIPTION OF THE DRAWINGS

FIG. 1 is a diagram illustrating a configuration of a sales data processing system according to an embodiment.

FIG. 2 is a perspective view illustrating an external appearance of a POS terminal according to the embodiment.

FIG. 3 is a diagram illustrating a hardware configuration of the POS terminal according to the embodiment.

FIG. 4 is a diagram illustrating a data structure stored in an internal content storage region.

FIG. 5 is a diagram illustrating a data structure stored in a commodity master storage region.

FIG. 6 is a function block diagram illustrating a functional configuration of the POS terminal.

FIG. 7 illustrates an example of a language selection screen.

FIGS. 8, 9, 10 and 11 illustrate examples of receipts.

FIG. 12 is a flowchart illustrating an example of sales data processing executed by the POS terminal.

### DETAILED DESCRIPTION

Embodiments provide a sales data processing apparatus and a program that supports multiple languages to be printed on a single receipt and can improve convenience.

A point of sale apparatus according to an embodiment includes an input device, an output device, and a processor. The processor is programmed to receive commodity information corresponding to a commodity that is a subject of a transaction, and generate receipt data including a first character string indicating a name of the commodity in a first language. The input device receives a selection of a second language different from the first language. The processor adds, to the generated receipt data, a second character string indicating a name of the commodity in the selected second language, and performs a settlement processing of the transaction based on the received commodity information. The output device outputs the receipt data including the first character string and the second character string.

Hereinafter, a point of sale (POS) apparatus and a program according to an embodiment will be described with reference to the drawings. In the following embodiment, an example applied to a sales system introduced to a retail store (store) such as a supermarket will be described, but the embodiment is not limited to this.

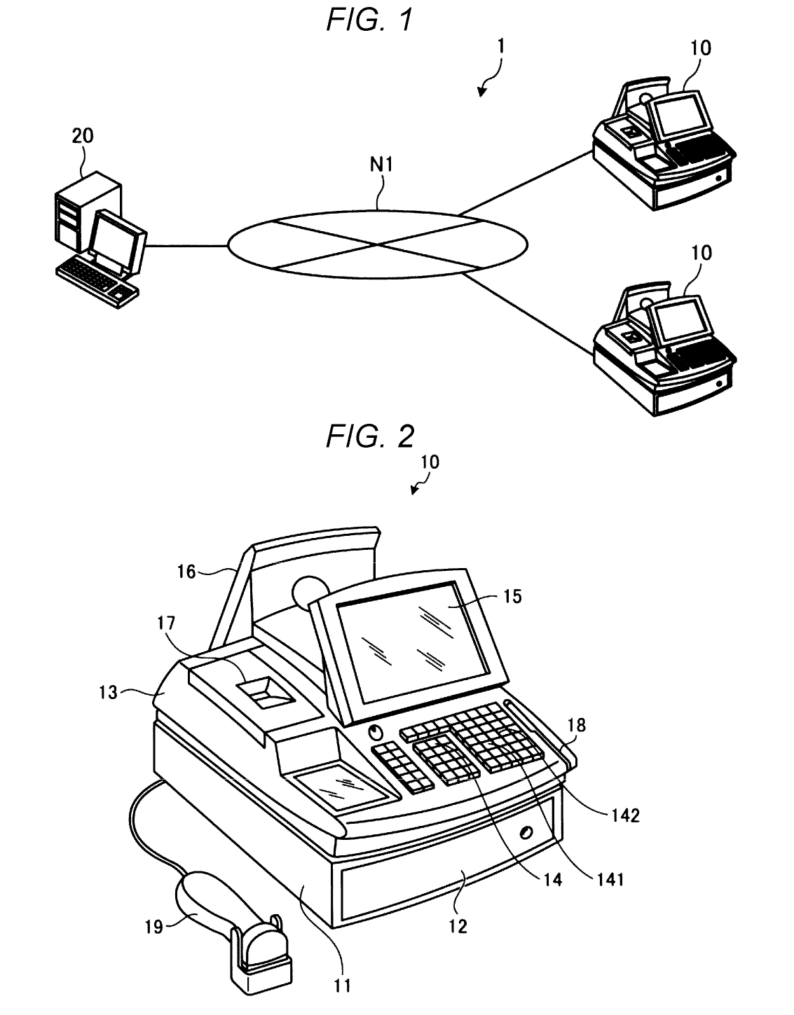

FIG. 1 is a diagram illustrating an example of a system configuration of a sales data processing system 1 according to the embodiment. As illustrated in FIG. 1, the sales data processing system 1 includes a POS terminal 10 and a server 20. The POS terminal 10 and the server 20 are connected to each other via a network N1. The network N1 is configured with, for example, the Internet or a dedicated line. The number of POS terminals 10 and the servers 20 connected to the network N1 is not particularly limited.

The POS terminal 10 is an example of a sales data processing apparatus. One or a plurality of POS terminals 10 are provided for each store, and the POS terminal 10 performs processing relating to settlement of commodity to be purchased by a customer, according to an operation of an operator such as a store clerk.

The server 20 is an example of an external device. The server 20 is a server device that is managed by, for example, a company which manages a store where the POS terminal 10 is located or a third party organization different from the company. The server 20 provides additional information to the POS terminal 10, as described below. In the present embodiment, the server 20 is realized by one server device, but is not limited thereto, and may be a cloud server realized by cooperation of a plurality of server devices.

FIG. 2 is a perspective view illustrating an external appearance of the POS terminal 10. The POS terminal 10 is positioned on a drawer housing 11, and can control an opening operation of a drawer 12 of the drawer housing 11. The drawer 12 stores cash received from a customer and cash used for change and the like. The POS terminal 10 may include an automatic changer instead of the drawer housing 11 or the automatic changer together with the drawer housing 11. A main housing 13 of the POS terminal 10 is provided with a keyboard 14 and a first display device 15 on an upper right side.

The keyboard 14 includes various keys for operating the POS terminal 10. The keyboard 14 includes, for example, a total key 141 and a current total key 142. The total key 141 is an operating element for instructing an end of sales registration (to be described below). The current total key 142 is an operating element for instructing start of settlement processing (to be described below).

The first display device 15 is a touch panel display with a touch panel overlaid on a display surface. The first display device 15 displays, for example, a screen to be viewed by an operator such as a store clerk. The main body housing 13 includes a second display device 16 on an upper rear side thereof. The second display device 16 is a touch panel display with a touch panel overlaid on a display surface. The second display device 16 displays, for example, a screen to be viewed by a customer who purchases commodity.

The POS terminal 10 includes a printing device 17 provided on an upper left side of the main body housing 13. The printing device 17 is a printer that prints a receipt, a journal, and the like on paper, on a per transaction basis. The paper is an example of a printing medium. The paper may be a roll paper wound in a roll form or may be paper sheets independently separated.

The POS terminal 10 includes a card reader 18 in a groove on a right side surface of the main body housing 13. The card reader 18 reads information relating to electronic settlement from a card medium such as a credit card or a debit card provided by a customer.

In addition, the POS terminal 10 includes a hand-held scanner device 19. The scanner device 19 reads a commodity code for identifying a commodity from a code symbol attached to the commodity.

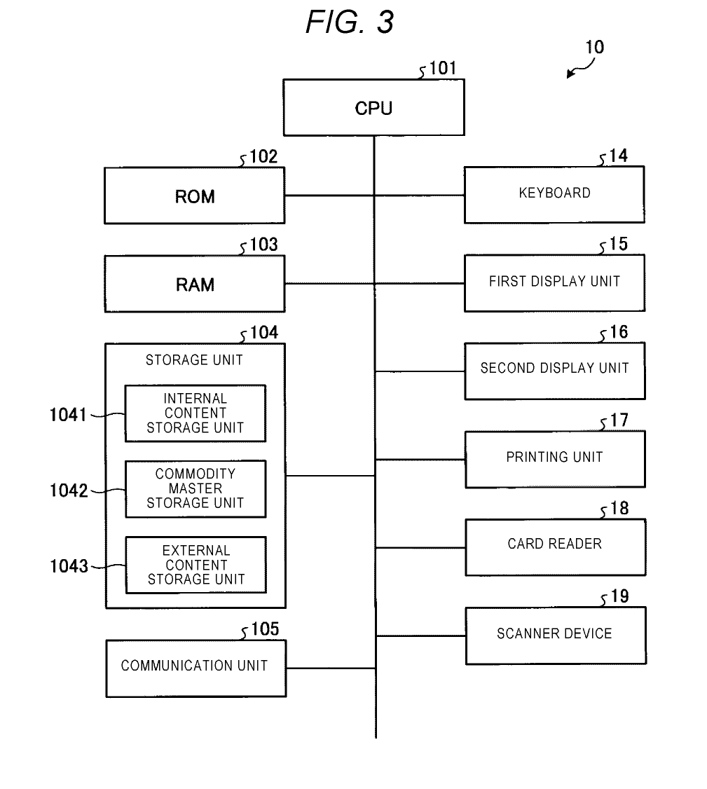

FIG. 3 is a diagram illustrating a hardware configuration of the POS terminal 10. The POS terminal 10 includes a central processing unit (CPU) 101, a read only memory (ROM) 102, a random access memory (RAM) 103, a storage device 104, a communication interface 105, the keyboard 14, the first display device 15, the second display device 16, the printing device 17, the card reader 18, and the scanner device 19.

The CPU 101 is a processor, and executes a program stored in the ROM 102 or the storage device 104, thereby controlling operations of the POS terminal 10. The ROM 102 is a storage medium that stores various programs and data which can be executed by the CPU 101. The RAM 103 is a storage medium that temporarily stores various programs and rewrites various data. The CPU 101 executes a program stored in the ROM 102, the storage device 104, or the like by using the RAM 103 as a work area (work region).

The storage device 104 is a storage device such as a hard disk drive (HDD) or a solid state drive (SSD). The storage device 104 stores a program can be executed by the CPU 101 and various setting information.

In addition, the storage device includes an internal content region 1041, a commodity master storage region 1042, and an external content storage region 1043. The regions 1041, 1042 and 1043 each store specific content to be described below.

The internal content storage region 1041 stores content data to be used for display or print output. The internal content storage region 1041 stores content data (hereinafter, referred to as internal content) indicated by the language for each of a plurality of languages. More specifically, the internal content storage region 1041 stores the internal content in the language in association with a language code for identifying each language.

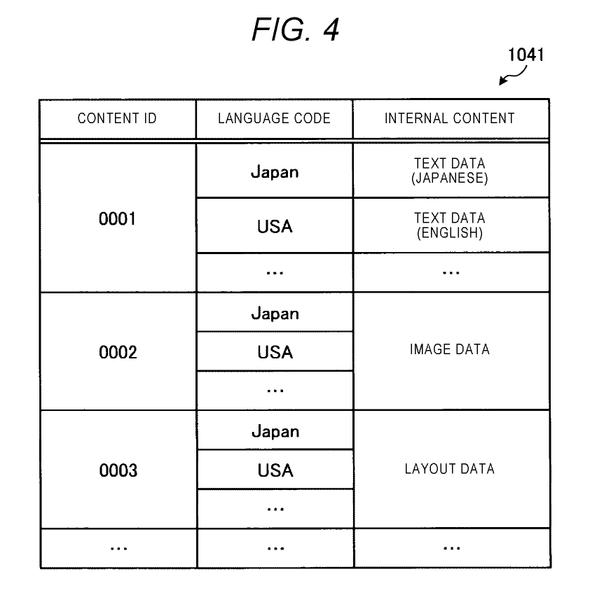

FIG. 4 is a diagram illustrating a data configuration of the internal content storage region 1041. As illustrated in FIG. 4, the internal content storage region 1041 stores a content ID, a language code, and internal content in association with each other.

The content ID is an identifier for identifying the internal content. The internal content is classified as for display or for printing, and according to an output target and the like. For example, if the internal content is for display, the internal content for a language selection screen (to be described below), a display screen relating to sales registration, and a display screen for settlement processing are stored, respectively. In addition, if the internal content is for printing, the internal content for outputting a receipt and for outputting a journal are stored, respectively. The content ID is used to identify the internal content.

Multiple language codes are associated with each content ID. Each language code is identification information for identifying a corresponding language that can be handled by the POS terminal 10. The internal content created in a corresponding language is associated with the language code.

The internal content is content data to be displayed or printed. The internal content in the present embodiment includes text data indicating a predetermined character string such as an item name and a message. Here, the internal content in each language associated with the same content ID indicates the same matter or meaning. That is, the internal content of each language associated with the same content ID translates similarly.

The internal content is not limited to text data and may be other types of content data or may include a plurality of types of content data. For example, the internal content may be image data such as a logo mark and an illustration. In addition, the internal content may be layout data for defining a layout of content for output. By combining the layout data with other internal contents (text data, image data), a screen layout, a printing layout, and the like are defined. In addition, the internal content having the same output form in each language may have the same internal content between the respective languages, as illustrated in the content IDs “0002” and “0003”.

In addition, it is assumed that the external content storage region 1043 has the same data configuration as the internal content storage region 1041.

Referring back to FIG. 3, the commodity master storage region 1042 stores commodity information on commodities. The commodity master storage region 1042 stores the commodity information of each commodity in each of a plurality of languages. More specifically, the commodity master storage region 1042 stores, for each commodity code that can identify the commodities, the commodity information in each language in association with a language code for identifying the language.

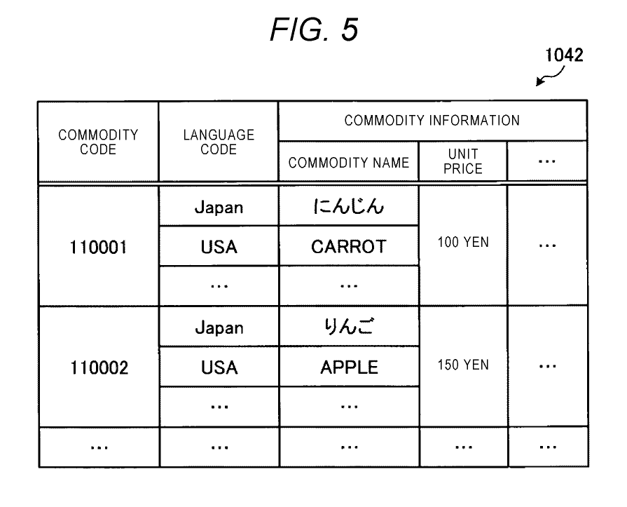

FIG. 5 is a diagram illustrating a data configuration of the commodity master storage region 1042. As illustrated in FIG. 5, the commodity master storage region 1042 stores the commodity code, the language code, and the commodity information in association with each other.

The commodity code is identification information that can identify a commodity. For example, a JAN code (Japanese Accepted Name) or the like can be used for the identification information. The language code is identification information for identifying each language that can be handled by the POS terminal 10. The commodity information indicated by the corresponding language is stored in association with the language code.

The commodity information includes information on the commodities such as a commodity name of a commodity corresponding to a commodity code and a price per unit quantity (unit price). Here, the commodity information in each language associated with the same commodity code indicates the same meaning. That is, the commodity information of each language associated with the same commodity code translates similarly.

The commodity information is not limited to the commodity name or the unit price and may include other data. For example, the commodity information may include the type of a commodity and data in which a place of origin and a producer are represented as text. In addition, when the commodity is a medicine, the commodity information may include data in which descriptive text, notes, and the like on the medicine are represented as text. In addition, the commodity information may include image data in which an image and an illustration of the commodity are represented. The commodity information (unit price and the like) having the same output form in each language may hold the same commodity information for a plurality of languages.

Referring back to FIG. 3, the communication interface 105 enables communication with each device connected to the network N1. Specifically, the communication interface 105 communicates with the server 20 connected to the network N1 under the control of the CPU 101.

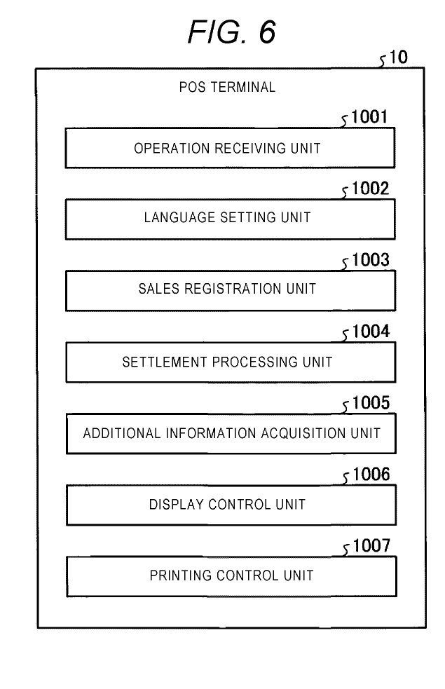

Next, a characteristic function of the POS terminal 10 will be described. FIG. 6 is a function block diagram illustrating a functional configuration of the POS terminal 10.

The CPU 101 of the POS terminal 10 develops a program stored in the storage device 104 in the RAM and executes the program, thereby, realizing each functional unit illustrated in FIG. 6. Specifically, the CPU 101 includes an operation receiving unit 1001, a language setting unit 1002, a sales registration unit 1003, a settlement processing unit 1004, an additional information acquisition unit 1005, a display control unit 1006, and a printing control unit 1007, as the functional units.

The operation receiving unit 1001 receives various operations via the keyboard 14. In addition, the operation receiving unit 1001 receives various operations via a touch panel of the first display device 15, a touch panel of the second display device 16, or the like.

The language setting unit 1002 is a functional unit that sets a language used for display or printing. When an operation to designate a language is input via the keyboard 14, the touch panel of the first display device 15, the touch panel of the second display device 16, and the like, the language setting unit 1002 sets the designated language for display or printing to a language corresponding to the operation. In the present embodiment, the language setting unit 1002 receives designation (selection) of a first language and a second language from among a plurality of languages (language codes) that can be handled by the POS terminal 10.

The first language is normally used by the POS terminal 10. For example, the first language is selected at the time of initial activation of the POS terminal 10, and a language code of the selected language is set (stored) in the storage device 104 or the like as a default language setting. As the first language, it is preferable to select, for example, a language of a country where the POS terminal 10 is placed or a language that an operator of the POS terminal 10 can understand. A method of selecting the first language is not particularly limited. In addition, the first language may be preset. In the present embodiment, it is assumed that “Japanese” is set as the first language.

The second language is temporarily used at the time of transacting commodities and can be selected on a per transaction basis. Here, the transaction means a period during which sales registration and settlement processing are performed for one customer. The second language is selected at the start of the transaction or during the transaction by a customer such as a tourist visiting Japan, and a language code of the selected language is set (stored) in the RAM during the transaction.

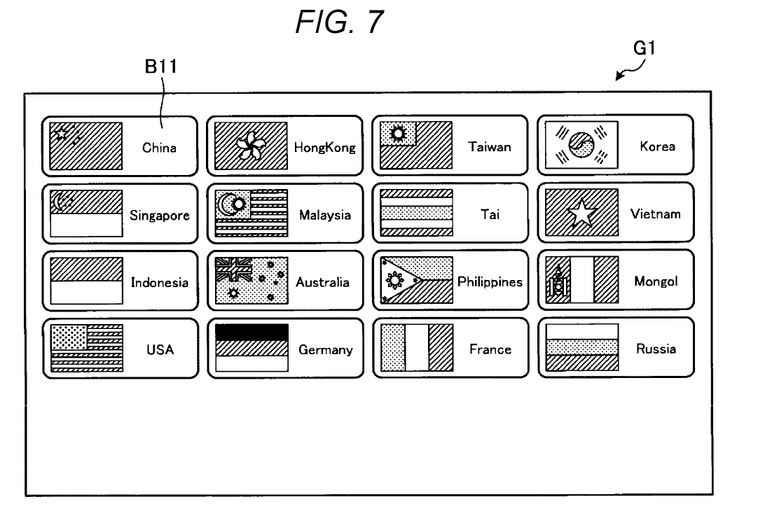

The language setting unit 1002 cooperates with the display control unit 1006 to display a language selection screen (see FIG. 7) for selecting the second language on the second display device 16 for a customer and sets one language selected from the language selection screen as the second language. The language selection screen will be described below.

The sales registration unit 1003 performs sales registration of a commodity purchased by a customer. For example, if a commodity code is read from a code symbol attached to the commodity by the scanner device 19, the sales registration unit 1003 specifies the commodity corresponding to the commodity code from the commodity master storage region 1042 and performs sales registration. In addition, the settlement processing unit 1004 performs the same processing as described above, thereby, performing sales registration of the commodity specified by the operation received by the operation receiving unit 1001. In addition, the sales registration unit 1003 calculates a commodity price (unit price×quantity) of each commodity, a total amount of money (or subtotal amount of money) of the commodity price, and the like, based on the unit price and quantity of the commodities of which sales are registered. The term “sales registration” means that a commodity code of the specified commodity is stored in the RAM 103 in association with the number of purchased commodities, a commodity price, and the like.

The settlement processing unit 1004 performs settlement processing of a commodity, based on sales data of the commodity registered for sales. For example, the settlement processing unit 1004 performs settlement processing to settle the total amount of money of the respective commodities registered for sales with the amount of money (payment amount) paid by a customer in response to an operation of the current total key 142. In addition, the settlement processing unit 1004 calculates a change amount by subtracting the total amount of money from the payment amount. The payment amount is not limited to cash and may be paid according to electronic payment information read from a medium such as a credit card or a debit card.

The additional information acquisition unit 1005 acquires additional information provided from the server 20 via the communication interface 105. For example, the additional information acquisition unit 1005 acquires additional information periodically or non-periodically from the server 20. In addition, the additional information acquisition unit 1005 acquires additional information from the server 20 by transmitting an acquisition request for additional information to the server 20.

The additional information includes content data (hereinafter, referred to as external content) that can be used for display and output of printing. Specifically, the additional information of the present embodiment includes an external content ID, a language code, and external content.

The external content ID is an identifier for identifying the additional information (external content). Multiple language codes are associated with the external content ID. In addition, the language code is associated with external content created by using a corresponding language. The external content includes the same text data or the like as the above-described internal content. Here, the external content of each language associated with the same external content ID (additional information) indicates the same matter or meaning. That is, the external content of each language associated with the same external content ID translates similarly. The external content having the same output form in each language may have the same external content between a plurality of languages.

The content indicated by the external content is not limited in particular, and various forms can be made. For example, the external content may be advertisement information for advertising a store where the POS terminal 10 is placed or a specified commodity. In addition, the external content maybe region information on a region or country where the POS terminal 10 is placed. In addition, the external content may be service information such as a discount coupon that can be used at a store where the POS terminal 10 is placed or other stores.

In addition, the additional information may include other data other than the external content. For example, the additional information may include data (hereinafter, referred to as an additional condition) for defining a condition relating to an output of the external content. Conditions such as outputting the external content when a specific language is set, and outputting the external content in a specified time period may be set as the additional condition.

If the additional information is acquired from the server 20, the additional information acquisition unit 1005 stores the external content and the like included in the additional information in the external content storage region 1043. The external content storage region 1043 stores the external content and, for example, has the same data configuration (see FIG. 5) as the above-described internal content storage region 1041. The additional information acquisition unit 1005 may assign an external content ID at the time of storing in the external content storage region 1043. In addition, it is assumed that, if other data having different additional conditions is included in the additional information, the other data is stored in the external content storage region 1043 in association with the corresponding external content ID.

The display control unit 1006 is an example of a display control unit. The display control unit 1006 causes the first display device 15 or the second display device 16 to display various screens relating to a transaction of the commodity in a language set by the language setting unit 1002.

If the second language is not set, the display control unit 1006 causes the first display device 15 and the second display device 16 to display various types of information and screens in the first language. Specifically, the display control unit 1006 causes the first display device 15 and the second display device 16 to display various types of information and screens, from the internal content of each language stored in the internal content storage region 1041, using the internal content of the language code (hereinafter, simply referred to as a first language) set as the first language. It is assumed that the internal content (content ID) becoming a display target is preset corresponding to a screen to be displayed, processing content, and the like.

In addition, if the second language is not set, the display control unit 1006 displays a language selection screen for selecting the second language on the second display device 16 by cooperating with the language setting unit 1002 and the settlement processing unit 1004.

FIG. 7 illustrates an example of the language selection screen. A language selection screen G1 illustrated in FIG. 7 displays the respective languages that can be handled by the POS terminal 10 as national flags of countries that primarily use the languages. An operating element B11 to which the national flag is attached is configured to be selectable. If a selection operation of any one of the operating elements B11 is received, the language setting unit 1002 sets a language code of a language corresponding to a national flag of the selected operating element B11 as the second language.

If the second language is set by the language setting unit 1002, the display control unit 1006 causes various types of information and screens to be displayed for a customer on the second display device 16 in the set second language. Specifically, the display control unit 1006 displays various types of information and screens on the second display device 16, using internal content of a language code (hereinafter, also simply referred to as a second language) set in the second language among the internal contents for each language stored in the internal content storage region 1041.

It is assumed that the language selection screen is not limited to FIG. 7. For example, the display control unit 1006 may cause the language selection screen to display operating elements indicating a country name, a message prompting language selection, and the like in each language that can be handled by the POS terminal 10. In addition, the display control unit 1006 may display the first language on the language selection screen as an option (operating element) or may not display the first language.

In addition, it is assumed that the timing when the language selection screen is displayed is not limited in particular as long as the target transaction does not end. For example, the display control unit 1006 may display the language selection screen at a time when the sales registration unit 1003 starts sales registration relating to one transaction. In addition, the display control unit 1006 may display the language selection screen before the sales registration unit 1003 starts the sales registration relating to a transaction. “Before starting the sales registration” means a period from an end of a transaction of a previous customer to a start of a transaction of a next customer. In addition, for example, if the second language is set for outputting a receipt, the display control unit 1006 may cause the second display device 16 to display the language selection screen until the settlement processing unit 1004 starts the settlement processing after the sales registration unit 1003 completes the sales registration relating to the target transaction.

In addition, the display control unit 1006 may cause other information to be displayed on the same screen as the language selection screen. For example, the display control unit 1006 may display commodity information, commodity amount of money, total amount of money, and the like relating to commodities registered for sales in the same screen as the language selection screen. In addition, the display control unit 1006 may cause the second display device 16 to display external content stored in the external content storage region 1043. It is assumed that, if setting the second language is completed, the display control unit 1006 causes the second display device 16 to display commodity information (commodity name) and external content in the second language.

The printing control unit 1007 is an example of a generation unit, an addition unit, and an output unit. The printing control unit 1007 generates receipt data representing transaction content of one transaction. The transaction content includes a store name and date and time in which the transaction is made, a transaction number for identifying the transaction, and the like, in addition to details of a commodity registered for sales in one transaction, and content (total amount of money, payment amount of money, exchange amount of money, and the like) of settlement processing with respect to the commodity.

Specifically, if the second language is not set, the printing control unit 1007 generates receipt data including a character string representing the transaction content in the first language. In addition, if setting the second language is completed, the printing control unit 1007 adds a character string in the second language having a meaning similar to a character string in the first language included in the receipt data. Then, the printing control unit 1007 causes the printing device 17 to print the generated receipt data, thereby, outputting (issuing) a receipt representing the content of one transaction. The issued receipt is handed over to a customer at the end of the transaction.

Here, an operation of the printing control unit 1007 when the second language is set will be described. If the settlement processing of the settlement processing unit 1004 is completed, the printing control unit 1007 extracts commodity information in the first language from the commodity information associated with a commodity code of a commodity registered for sales. In addition, the printing control unit 1007 extracts commodity information in the second language from the commodity information associated with the commodity code of the commodity registered for sales. Then, the printing control unit 1007 generates receipt data including the commodity information in the first language and the second language for each commodity registered for sales.

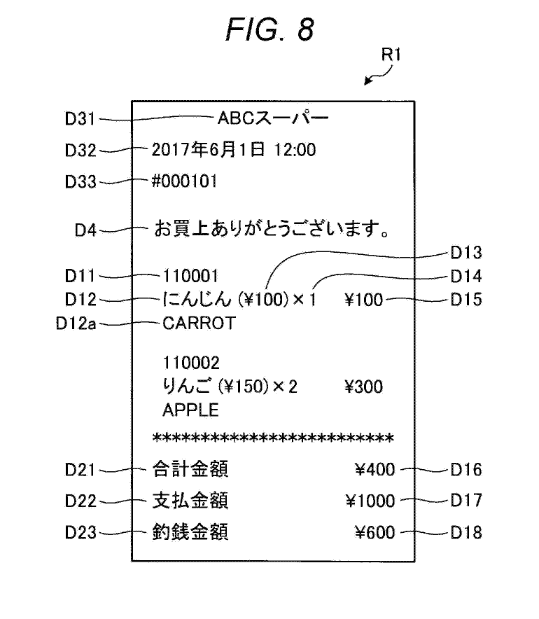

FIG. 8 illustrates an example of a receipt (receipt data). As illustrated in FIG. 8, a receipt R1 includes a commodity code D11, commodity names D12 and D12a, a unit price D13, the number of units D14, a commodity amount D15, a total amount D16, a payment amount D17, and a change amount D18 with respect to the commodities registered in one transaction, as transaction content. Item names D21, D22, and D23 for describing items are printed with each of the total amount D16, the payment amount D17, and the change amount D18.

In addition, the receipt R1 includes a store name D31, transaction date and time D32, and a transaction number D33 of a store where the transaction is made as other items in addition to the transaction content. Furthermore, the receipt R1 includes a message D4.

The item names D21, D22, and D23, the store name D31, and the message D4 are defined by, for example, internal content (text data) for outputting a receipt. A layout of the receipt R1 is defined by internal content (layout data) for outputting the receipt. In addition, the transaction date and time D32 and the transaction number D33 are data generated dynamically on a per transaction basis. It is assumed that a display form of the transaction date and time D32 is stored for each language as internal contents.

Here, considering the commodity name included in the transaction content, the commodity name D12 represented in the first language (Japanese) and a commodity name D12a represented in the second language (English) are written together in the receipt R1. Specifically, the printing control unit 1007 adds one word (for example, commodity name D12a) in the second language having a similar meaning as one word (for example, commodity name D12) in the first language and prints (outputs) the result. Thereby, the commodity names having similar meanings are written together as illustrated in FIG. 8.

As such, the printing control unit 1007 outputs (prints) a receipt in which the commodity name having a similar meaning is written together with respect to the commodity registered for sales, on condition that the second language is set. Thereby, a customer such as a tourist who visits Japan and can understand the second language can easily understand the transaction content (commodity name D12a) printed on the receipt. In addition, an operator who can understand the first language can easily understand the transaction content (commodity name D12) printed on the receipt. In addition, the operator and the customer (tourist visiting Japan) can easily recognize in common the transaction content printed on the receipt.

An item in addition to the commodity name is output in the first language (Japanese) on the receipt R1, but other items may be output in a state where the second language is added. In this case, the printing control unit 1007 adds internal content in the second language having a meaning similar to the internal content (text data) in the first language included in the receipt data in association with each other, on condition that the second language is selected.

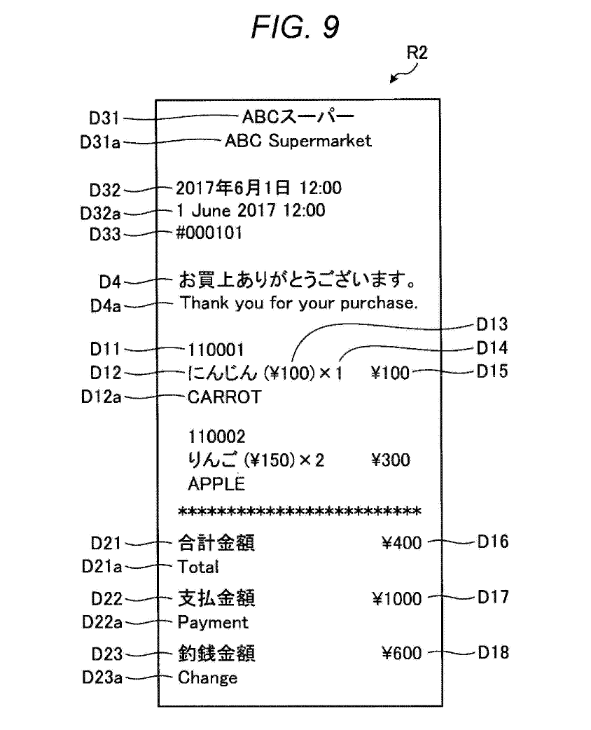

Specifically, the printing control unit 1007 extracts the internal content in the second language corresponding to the internal content in the first language from among the internal contents stored in the internal content storage region 1041 for outputting the receipt. Then, the printing control unit 1007 adds the extracted internal content in the second language below the internal content in the first language and prints the result. Thereby, the internal contents having similar meanings are written together as illustrated in FIG. 9.

FIG. 9 illustrates another example of the receipt (receipt data). A receipt R2 in FIG. 9 illustrates the same transaction content as in the receipt R1 in FIG. 8, but is different from the receipt R1 in that items other than the transaction content are written together in both the first language and the second language.

Specifically, in the receipt R2, item names D21, D22, and D23 represented in the first language are written together with item names D21a, D22a, and D23a represented in the second language having similar meanings, respectively. In addition, a store name D31 and a message D4 represented in the first language are written together with a store name D31a and a message D4a represented in the second language having similar meanings, respectively. In addition, transaction date and time D32a represented in the second language is also written together with respect to transaction date and time D32.

As such, the printing control unit 1007 prints a receipt in which items (contents) other than the transaction content having similar meanings are associated with each other, on condition that the second language is set. Thereby, a customer such as a tourist who visits Japan and can understand the second language can easily understand the items, other than the transaction content, which are printed on the receipt. In addition, an operator who can understand the first language can easily understand the items, other than the transaction content, which are printed on the receipt. In addition, the operator and the customer (a tourist who visits Japan) can easily recognize in common the items, other than the transaction content, which are printed on the receipt.

In addition, an amount of money such as the unit price D13 of a commodity or the total amount D16 is represented by a currency unit of a main country (hereinafter, a first country) that uses the first language in the receipts R1 and R2, but the amount of money may be output in a state where information in the second language is added.

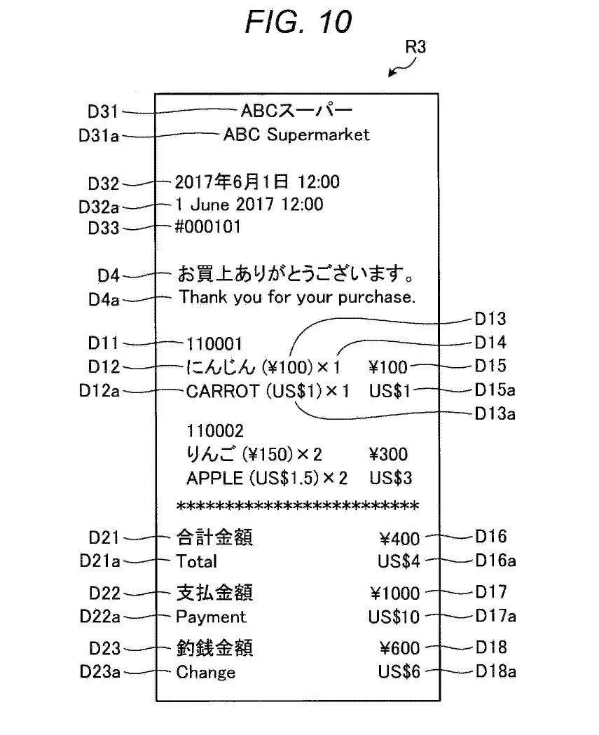

For example, the printing control unit 1007 may add an amount of money converted into a currency unit of a main country (hereinafter, a second country) that uses the second language in association with the amount of money represented in the currency unit of the first country. In this case, the printing control unit 1007 converts the amount of money represented in the currency unit of the first country into the amount of money of the currency unit of the second country, based on an exchange rate between the first country and the second country. Then, the printing control unit 1007 adds the amount of money represented in the currency unit of the second country below the amount of money represented in the currency unit of the first country, and prints the result. Thereby, as illustrated in FIG. 10, the amount of money represented in the currency unit of the first country, and the amount of money represented in the currency unit of the second country are written together in two stages.

FIG. 10 illustrates still another example of a receipt. A receipt R3 in FIG. 10 illustrates the same transaction content as in the receipt R1 in FIG. 8, but the receipt R3 is different from the receipt R1 in that an amount of money such as a total amount is written in two currencies. Specifically, in the receipt R3, a unit price D13a, a commodity amount D15a, a total amount D16a, a payment amount D17a, and an exchange amount D18a which are represented in the currency unit of the second country (United States)are written together with respect to the unit price D13, the commodity amount D15, the total amount D16, the payment amount D17, and the exchange amount D18 which are represented in the currency unit of the first country (Japan), respectively. In the example of FIG. 10, an example in which an exchange rate of 1 US dollar=100 yen is used is illustrated, for the sake of simple description.

As such, the printing control unit 1007 prints a receipt in which the amount of money represented in the currency unit of the first country is associated with the amount of money converted into the currency unit of the second country, on condition that the second language is set. Thereby, since a customer such as a tourist visiting Japan can easily confirm the amount of money in the currency unit of the second country (home country) corresponding to the amount of money indicated by the currency unit of the first country, convenience in confirming the amount of money can be improved. An exchange rate may be acquired from an external server device or may be stored in advance in the storage device 104 or the like. In addition, the printing control unit 1007 may include the exchange rate used for the conversion in the receipt data to print the receipt.

In addition, the printing control unit 1007 may include additional information (external content) stored in the external content storage region 1043 in the receipt data to print the receipt. In this case, the printing control unit 1007 causes the external content in the first language to be included in the receipt data for printing. In addition, the printing control unit 1007 adds and prints external content in the second language having a similar meaning as and in association with the external content in the first language, on condition that setting the second language is completed.

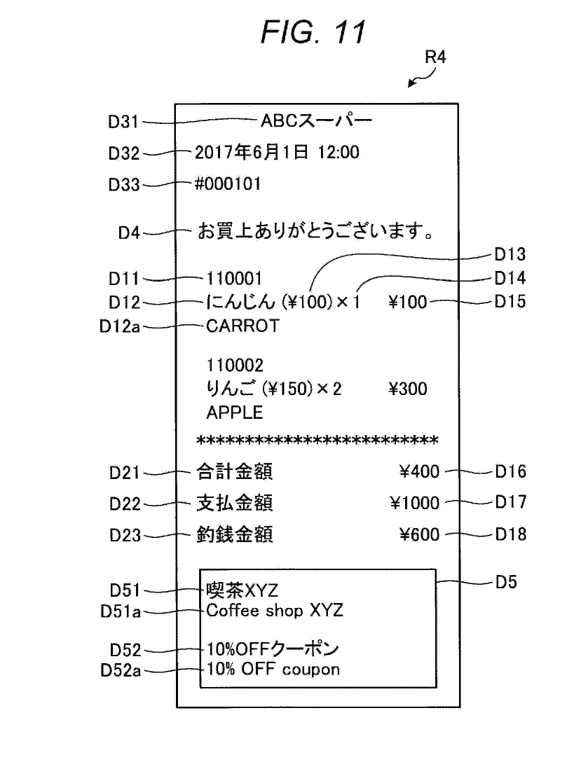

Specifically, the printing control unit 1007 extracts the external content in the second language corresponding to the external content in the first language from among the external content items stored in the external content storage region 1043. Then, the printing control unit 1007 adds the extracted external content in the second language below the external content in the first language and prints the result. Thereby, as illustrated in FIG. 11, the external contents having similar meaning are written together.

A method of selecting the external content as a target of output (printing) is not particularly limited. For example, the printing control unit 1007 may set all external content items stored in the external content storage region 1043 as an output target. In addition, the printing control unit 1007 may select the external content corresponding to the second language or a condition of the transaction date and time, based on the condition information stored in association with the external content.

FIG. 11 illustrates an example of a receipt to which external content is added. A receipt R4 in FIG. 11 illustrates the same transaction content as in the receipt R1 in FIG. 8, but the receipt R4 is different from the receipt R1 in that the external content D5 is added to an end portion of the receipt. The receipt R4 is an example in which setting the second language (English) is completed, and illustrates an example in which the external content in the first language and the external content in the second language are associated with each other and are printed. Specifically, a character string D51 in the first language and a character string D51a in the second language which are included in the external content D5 and have similar meanings are written together. In addition, a character string D52 in the first language and a character string D52a in the second language which are included in the external content D5 and have similar meanings are written together.

As such, the printing control unit 1007 prints a receipt in which the external content items having similar meanings are associated with each other, on condition that the second language is set. Thereby, a tourist who is a customer and visits Japan can easily understand the external content printed on the receipt. In addition, an operator who can understand the first language can easily understand the external content printed on the receipt. In addition, the operator and the customer (a tourist visiting Japan) can easily recognize the external content printed on the receipt in common.

The position of the external content is not limited to the end portion of the receipt. For example, the printing control unit 1007 may arrange the external content at another portion such as the beginning portion of the receipt. In addition, if the printing device 17 has a configuration in which both sides of paper can be printed, the printing control unit 1007 may cause the transaction content to be printed on the one side of the paper and the external content to be printed on the other side of the paper.

In addition, the printing control unit 1007 causes the printing device 17 to print a journal for being stored in a store together with a receipt for a customer. Specifically, the printing control unit 1007 causes the journal representing the transaction content in the first language to be printed regardless of whether or not the second language is set. The printing control unit 1007 may include a language code of the second language used for printing the receipt in the journal and print the receipt.

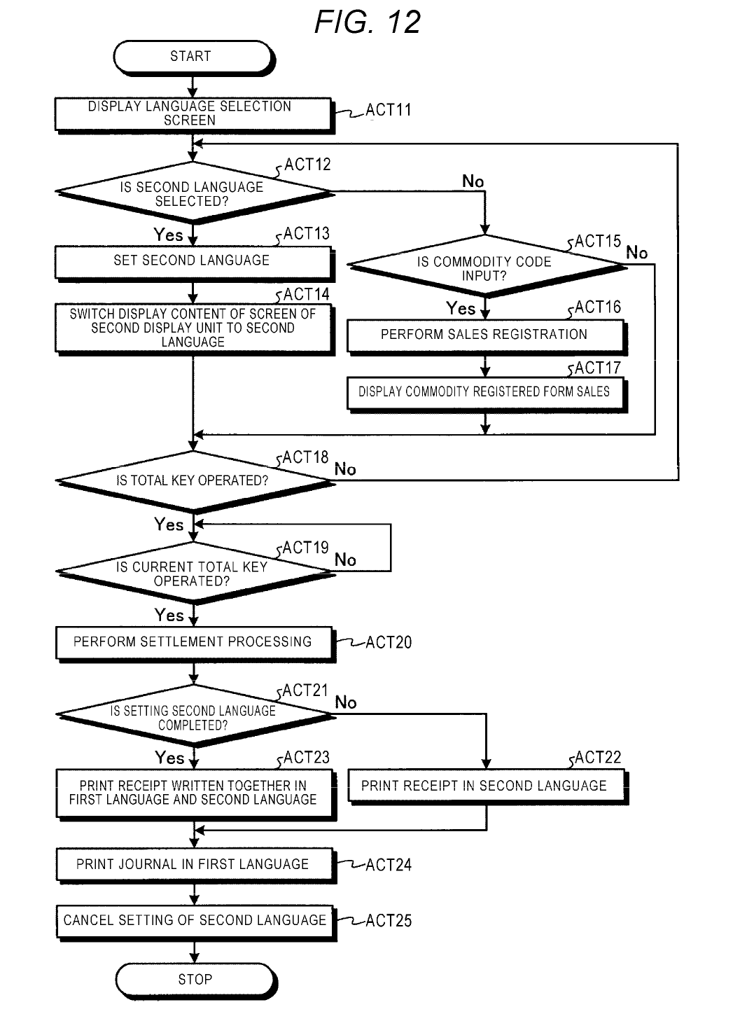

Hereinafter, an operation of the POS terminal 10 having the above-described configuration will be described. FIG. 12 is a flowchart illustrating an example of sales data processing performed by the POS terminal 10. It is assumed that the first language is preset in the present processing. In addition, it is assumed that additional information (external content) provided from the server 20 is previously stored in the external content storage region 1043.

First, if start of transaction is instructed by a predetermined operation, the display control unit 1006 displays a language selection screen on the second display device 16 (Act 11).

The language setting unit 1002 determines whether or not one language (second language) is selected from the language selection screen displayed in Act 11 (Act 12). Here, if one language is selected (Act 12; Yes), the language setting unit 1002 sets language code of the selected language as the second language (Act 13). In addition, if one language is not selected from the language selection screen or if setting the second language is completed (Act 12; No), the processing proceeds to Act 15. The display control unit 1006 may remove the language selection screen in response to the setting of the second language.

If the second language is set in Act 13, the display control unit 1006 switches display content on a screen of the second display device 16 from the first language to the second language (Act 14) and the processing proceeds to Act 18.

Meanwhile, the sales registration unit 1003 waits for input of a commodity code from the scanner device 19. If the commodity code is input (Act 15; Yes), the sales registration unit 1003 proceeds to Act 16. If no commodity code is input (Act 15; No), the processing proceeds to Act 18. The processing of Act 15 (Act 18) may be performed together with or in parallel with the processing of Act 12.

The sales registration unit 1003 performs sales registration of a commodity with a commodity code input in Act 15 as a sales target (Act 16). Next, the display control unit 1006 causes the first display device 15 and the second display device 16 to display a commodity name, the number of purchases, and the like of the commodity, based on commodity information of the commodity registered for sales (Act 17), and proceeds to Act 18. If the second language is not set, the display control unit 1006 causes the first display device 15 and the second display device 16 to display the commodity information in the first language. In addition, if setting the second language is completed, the display control unit 1006 causes the first display device 15 to display the commodity information in the first language and causes the second display device 16 to display the commodity information in the second language.

Subsequently, the sales registration unit 1003 determines whether or not the total key 141 is operated (Act 18). If the total key 141 is not operated (Act 18; No), the operation receiving unit 1001 returns the processing to Act 12. In addition, if the operation of the total key 141 is received (Act 18; Yes), the sales registration unit 1003 ends the sales registration and proceeds to the processing of Act 19.

Subsequently, the operation receiving unit 1001 waits until the current total key 142 is operated (Act 19; No). A payment amount of money paid by a customer is input during the waiting time. If the second language is set for output, the display control unit 1006 may cause the language selection screen to be displayed at the timing of starting the waiting in Act 19.

If an operation of the current total key 142 is received (Act 19; Yes), the settlement processing unit 1004 performs settlement processing of settling the total amount of each commodity registered with a payment amount from a customer (Act 20).

Subsequently, the printing control unit 1007 determines whether or not setting the second language is completed (Act 21). If the second language is not set (Act 21; No), the printing control unit 1007 generates receipt data representing the transaction content in the first language, based on the commodity registered for sales and content of the settlement processing (transaction content). Then, the printing control unit 1007 causes the printing device 17 to print the generated receipt data as a receipt on a paper medium (Act 22), and proceeds to Act 24.

In addition, if setting the second language is completed (Act 21; Yes), the printing control unit 1007 generates receipt data in which the transaction content and the like are written in both the first language and the second language. Then, the printing control unit 1007 causes the printing device 17 to print the generated receipt data as the receipt of the paper medium (Act 23), and proceeds to Act 24. The printing control unit 1007 may cause the external content stored in the external content storage region 1043 to be included in the receipt data for printing.

Subsequently, the printing control unit 1007 causes the printing device 17 to print a journal representing the transaction content in the first language (Act 24). If printing of the receipt and the journal is completed, the language setting unit 1002 cancels the setting of the second language (Act 25) and ends the present processing.

As described above, according to the present embodiment, if the second language is selected during the transaction or before a start of the transaction (before start of the sales registration), the POS terminal 10 generates receipt data representing transaction content and the like in the first language and the second language and prints the receipt data as a receipt. Thereby, the POS terminal 10 can support multiple languages in a single receipt.

In addition, the POS terminal 10 prints character strings having similar meanings in the first language and in the second language, in a state of being associated with each other. Thereby, the POS terminal 10 can cause an operator who can understand the first language and a customer such as a tourist who visits Japan and can understand the second language to recognize in common commodity information and other items printed on the receipt. Thus, the operator and the tourist easily confirm content of the receipt, and thereby, convenience can be improved.

As such, although an exemplary embodiment is described above, the embodiment is presented as an example, and it is not intended to limit the scope of the exemplary embodiment. The novel embodiment can be implemented in various other forms, and various omissions, substitutions, combinations and modifications can be made without departing from the scope of the embodiment. The embodiment and modifications thereof are included in the scope of the embodiment and are included in the embodiment described in the claims and the equivalent scope thereof.

For example, in the above embodiment, an example of outputting a receipt is described, but a target of output is not limited to a receipt. For example, the display control unit 1006 may display commodity information and various contents displayed on the second display device 16, using the first language and the second language. In addition, the printing control unit 1007 may print a journal in the same form as the receipt. Furthermore, printed items which are handed to a customer, other than the receipt may be printed by using the first language and the second language. For example, in a dispensing pharmacy or the like, there is a case where a document (hereinafter, referred to as a medicine information document) on which a description (content) such as a name, efficacy, usage, and the like of the medicine is printed is handed to a customer together with medicine. In such a case, the printing control unit 1007 may print the medicine information document in which a description of the medicine is represented using the first language and the second language.

In addition, in the above embodiment, a case where the second language is selected based on the language selection screen, but the second language selecting method is not limited thereto. For example, if the POS terminal 10 includes a passport reader capable of reading information held in the passport, the language setting unit 1002 may specify the nationality of a customer from the information read from the passport and set a language code corresponding to the nationality to the second language.

In addition, in the above-described embodiment, an example is described in which various contents of text data are written in the first language and the second language, but other types of contents may be written in the first language and the second language in the same manner. For example, if image data is prepared for each language as the internal content stored in the internal content storage region 1041, the image data in the first language and in the second language may be written together.

In addition, in the above-described embodiment, an example in which contents (text data) of the same type are written together is described, but the exemplary embodiment is not limited to this, and if the contents have similar meanings, content data of different types may be written together. In this case, for example, the internal content storage region 1041 stores image data (logo mark or the like) representing a character string in the first language as an illustration or the like in association with a language code of the first language, and stores text data representing the character string in another language in association with the corresponding language code, as internal content having the same content ID. Using the internal content, the printing control unit 1007 can print an image representing the character string in the first language and the character string (text) representing the character string of the image in the second language in association with each other.

In addition, in the above-described embodiment, the POS terminal 10 includes the internal content storage region 1041, the commodity master storage region 1042, and the external content storage region 1043, and the exemplary embodiment is not limited thereto. For example, an external device (a store server or the like provided in the store) in communication with the POS terminal 10 may include any one or all of the internal content storage region 1041, the commodity master storage region 1042, and the external content storage region 1043.

In addition, in the above-described embodiment, the contents in each language are prepared, and the contents to be used are switched according to the selected language. However, by using a known automatic translation technology, the content in the second language may be generated based on the content in the first language for each transaction. In this case, the content created in the first language is stored in the internal content storage region 1041 and the external content storage region 1043, and the display control unit 1006 and the printing control unit 1007 use the content automatically translated into the second language for output of the second display device 16 and a receipt. In this case, the automatic translation may be performed by the CPU 101 of the POS terminal 10 or maybe to be performed by an external device (a translation server or the like) connected to the network N1.

In addition, in the above-described embodiment, an example in which the first language is printed in an upper position and the second language is printed in a lower position with respect to the printing in the first language and the second language is described, but a printing method is not limited to this. For example, the second language may be printed in the upper position and the first language may be printed in the lower position. In addition, for example, the first language and the second language may be printed in parallel in a lateral direction.

In addition, in the above-described embodiment, an example in which a receipt of a paper medium is printed is described, but the exemplary embodiment is not limited to this, and the receipt may be configured to output in a form of an electronic receipt. In this case, the printing control unit 1007 generates the receipt data described in the above embodiment as an electronic receipt. If the electronic receipt is generated, the printing control unit 1007 outputs (transmits) the electronic receipt to an information terminal or the like owned by a customer relating to transaction via the communication interface 105 or the like.

Here, it is assumed that the electronic receipt generated by the printing control unit 1007 includes the same content as the content printed on a receipt of the paper medium. In addition, transaction content and other items represented in the first language and the second language are written together in the same manner as in the above embodiment. The electronic receipt may be a receipt obtained by converting receipt data into a structured form, based on a structured language such as an extensible markup language (XML). In addition, it is preferable that the electronic receipt is generated such that the form at the time of being displayed is the same display form as a receipt of a paper medium.

In addition, a method of providing the electronic receipt is not limited in particular, and various methods can be adopted. For example, if identification information for identifying a customer is obtained in advance by a system such as member registration, an address of an information terminal owned by a customer is registered in association with the identification information. When performing transaction, if the identification information of the customer is read from a medium such as a membership card owned by the customer by the card reader 18 or the like, the printing control unit 1007 outputs (transmits) the generated electronic receipt to an address of the information terminal associated with the identification information.

In addition, if the POS terminal 10 includes a short-distance wireless communication device conforming to a standard such as a near field communication (NFC) or the IBEACON (registered trademark), the electronic receipt may be provided via the short-distance wireless communication device. In this case, the printing control unit 1007 outputs (transmits) the electronic receipt to the information terminal owned by a customer via the short-distance wireless communication device. In addition, the electronic receipt may be provided not only to an information terminal of a customer directly from the POS terminal 10 but also to an information terminal of the customer via an external server device connected to the network N1 or the like.

The printing control unit 1007 may output either a receipt of a paper medium or an electronic receipt or may output both. For example, the printing control unit 1007 may switch an output destination in response to an operation of a store clerk or a customer received by the operation receiving unit 1001.

In addition, programs executed by the respective devices according to the above-described embodiment are provided in advance by being incorporated into a storage medium (ROM or HDD) included in the device, and the exemplary embodiment is not limited thereto. For example, the program may be recorded in a computer-readable recording medium such as a CD-ROM, a flexible disk (FD), a CD-R, or a digital versatile disk (DVD) as a file of an installable format or executable format. Furthermore, the storage medium includes not only a medium independent of a computer or an incorporated system, but also a storage medium in which a program transmitted via a LAN, the Internet, or the like is downloaded and stored or temporarily stored.

In addition, a program executed by the device according to the above-described embodiment may be stored in a computer connected to a network such as the Internet and may be downloaded via a network or may be provided or distributed via a network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A point of sale apparatus comprising:
an input device;
an output device; and
a processor programmed to:
receive commodity information corresponding to a commodity that is a subject of a transaction,
generate receipt data including a first character string indicating a name of the commodity in a first language,
receive, from the input device, a selection of a second language different from the first language,
add, to the generated receipt data, a second character string indicating a name of the commodity in the selected second language,
perform a settlement processing of the transaction based on the received commodity information, and
control the output device to output the receipt data including the first character string and the second character string.

2. The apparatus according to claim 1, wherein the output device is a printer that outputs the receipt data by printing a receipt with information regarding the transaction including the first character string and the second character string.

3. The apparatus according to claim 1, wherein the output device is a communication interface that outputs the print data by transmitting an electronic receipt with information regarding the transaction including the first character string and the second character string.

4. The apparatus according to claim 1, wherein the processor is further configured to:
add, to the receipt data, a third character string indicating additional information regarding the transaction in the first language, and
add, to the receipt data, a fourth character string indicating additional information regarding the transaction in the second language.

5. The apparatus according to claim 4, wherein the additional information includes instructions regarding the commodity.

6. The apparatus according to claim 4, further comprising:
a communication interface in communication with a server, wherein the additional information including the third and fourth character strings is received from the server via the communication interface.

7. The apparatus according to claim 1, wherein the processor is further configured to:
add, to the receipt data, a third character string indicating a total amount of money for the transaction in a first currency unit corresponding to a country whose primary language is the first language, and
add, to the receipt data, a fourth character string indicating the total amount of money for the transaction in a second currency unit corresponding to a country whose primary language is the second language.

8. The apparatus according to claim 1, further comprising:
a first display device positioned to face an operator of the device; and
a second display device positioned to face a customer who settles the transaction, wherein
the processor is further configured to:
control the first display device to display details of the transaction in the first language, and
control the second display device to display details of the transaction in the second language.

9. The apparatus according to claim 1, wherein:
the input device is a touch screen device, and
the processor is further programmed to control the touch screen device to display a plurality of selectable languages from which the selection of the second language is made.

10. The apparatus according to claim 1, further comprising:
a scanner configured to:
scan the commodity to extract the commodity information, and
provide the extracted commodity information to the processor.

11. A method of supporting multiple languages in a point of sale apparatus, the method comprising:
receiving commodity information corresponding to a commodity that is a subject of a transaction;
generating receipt data including a first character string indicating a name of the commodity in a first language;
receiving, from an input device, a selection of a second language different from the first language;
adding, to the generated receipt data, a second character string indicating a name of the commodity in the selected second language;
performing a settlement processing of the transaction based on the received commodity information; and
outputting the receipt data including the first character string and the second character string.

12. The method according to claim 11, wherein outputting the receipt data includes printing a receipt with information regarding the transaction including the first character string and the second character string.

13. The method according to claim 11, wherein outputting the print data includes transmitting an electronic receipt with information regarding the transaction including the first character string and the second character string.

14. The method according to claim 11, further comprising:
adding, to the receipt data, a third character string indicating additional information regarding the transaction in the first language; and
adding, to the receipt data, a fourth character string indicating additional information regarding the transaction in the second language.

15. The method according to claim 14, wherein the additional information includes instructions regarding the commodity.

16. The method according to claim 14, further comprising:
receiving, from a server, the additional information including the third and fourth character strings.

17. The method according to claim 11, further comprising:
adding, to the receipt data, a third character string indicating a total amount of money for the transaction in a first currency unit corresponding to a country whose primary language is the first language; and
adding, to the receipt data, a fourth character string indicating the total amount of money for the transaction in a second currency unit corresponding to a country whose primary language is the second language.

18. The method according to claim 11, further comprising:
controlling a first display device positioned to face an operator to display details of the transaction in the first language; and
controlling a second display device positioned to face a customer to display details of the transaction in the second language.

19. The method according to claim 11, wherein:
the selection of the second language is made from a touch screen device that displays a plurality of selectable languages.

20. The method according to claim 11, further comprising:
scanning, with a scanner, the commodity to extract the commodity information.
